(19) United States
(12) Patent Application Publication
(10) Pub. No.: US 2026/0206698 A1
(43) Pub. Date: Jul. 23, 2026

(54) AGRICULTURAL IRRIGATION METHOD, SYSTEM, DEVICE, MEDIUM, AND PRODUCT

(71) Applicant: Northwest Agriculture and Forestry University, Xianyang (CN)

(72) Inventors: Shikun SUN, Xianyang (CN); Baofeng SU, Xianyang (CN); Yihui WANG, Xianyang (CN); Jiahui DONG, Xianyang (CN); Guolong ZHAN, Xianyang (CN); Zhijun LI, Xianyang (CN); Yali YIN, Xianyang (CN); Jina ZHANG, Xianyang (CN)

(21) Appl. No.: 19/573,146

(22) Filed: Mar. 20, 2026

Related U.S. Application Data
(63) Continuation-in-part of application No. PCT/CN2024/131437, filed on Nov. 12, 2024.

(30) Foreign Application Priority Data
Oct. 22, 2024 (CN) 202411476677.2

(51) Int. Cl. A01G 25/16

(52) U.S. Cl. CPC A01G 25/167

(57) ABSTRACT

An agricultural irrigation method, system, device, and medium are provided. The method includes: acquiring a farmland condition data set of an area to be irrigated, and determining whether to generate a first irrigation instruction, where the first irrigation instruction is used to control a first solenoid valve and a first water pump on a first pipeline to be turned on, and a farmland is watered based on the first irrigation instruction; determining whether to generate a second irrigation instruction, where the second irrigation instruction is used to control a second solenoid valve and a second water pump on a second pipeline to be turned on, and the farmland is fertilized based on the second irrigation instruction; and determining whether to generate a third irrigation instruction, where pesticide is applied to the farmland based on the third irrigation instruction.

### CROSS-REFERENCE TO RELATED APPLICATION

The present disclosure is a Continuation-in-Part application of International Patent Application No. PCT/CN2024/131437, filed on Nov. 12, 2024, which claims the priority of Chinese Patent Application No. 202411476677.2 filed on Oct. 22, 2024 and entitled “AGRICULTURAL IRRIGATION METHOD, SYSTEM, DEVICE, MEDIUM, AND PRODUCT”, both of which are incorporated herein by reference in their entireties.

### TECHNICAL FIELD

The present disclosure relates to the field of agricultural irrigation, and in particular to an agricultural irrigation method, system, device, medium, and product.

### BACKGROUND

Agricultural irrigation refers to an agricultural activity that artificially provides water to crops to meet growth requirements. A conventional agricultural irrigation method mainly includes the following steps. First, farmers need to observe growth situation of crops and determine whether irrigation is needed. Then, water, fertilizer and pesticide are introduced into fields through diversion canals, pipelines or other irrigation facilities. When farmers determine that an irrigation amount is enough through observation, they turn off a valve to stop irrigation.

However, in a conventional agricultural irrigation process, farmers often can only make a rough estimate based on experience, and it is difficult to guarantee accuracy of irrigation.

### SUMMARY

An objective of the present disclosure is to provide an agricultural irrigation method, system, device, medium, and product, which can improve irrigation efficiency.

In order to achieve the above objective, the present disclosure provides the following solution.

In a first aspect, the present disclosure provides an agricultural irrigation method, including:
acquiring a farmland condition data set of an area to be irrigated, where the farmland condition data set includes minimum soil water content data, soil nutrient data, and expected crop disease index data;
determining whether to generate a first irrigation instruction based on a comparison result between the minimum soil water content data and farmland water-holding capacity data, where the first irrigation instruction is used to control a first solenoid valve and a first water pump on a first pipeline to be turned on, and a farmland is watered based on the first irrigation instruction;
determining whether to generate a second irrigation instruction based on a comparison result between the soil nutrient data and preset nutrient data, where the second irrigation instruction is used to control a second solenoid valve and a second water pump on a second pipeline to be turned on, and the farmland is fertilized based on the second irrigation instruction; and
determining whether to generate a third irrigation instruction based on a level of the expected crop disease index, where the third irrigation instruction is used to control a third solenoid valve and a third water pump on a third pipeline to be turned on, and pesticide is applied to the farmland based on the third irrigation instruction.

In a second aspect, the present disclosure provides an agricultural irrigation system, including:
an acquisition module, which is configured to acquire a farmland condition data set of an area to be irrigated, where the farmland condition data set includes minimum soil water content data, soil nutrient data, and expected crop disease index data; a first determining module, which is configured to determine whether to generate a first irrigation instruction based on a comparison result between the minimum soil water content data and farmland water-holding capacity data, where the first irrigation instruction is used to control a first solenoid valve and a first water pump on a first pipeline to be turned on, and a farmland is watered based on the first irrigation instruction; a second determining module, which is configured to determine whether to generate a second irrigation instruction based on a comparison result between the soil nutrient data and preset nutrient data, where the second irrigation instruction is used to control a second solenoid valve and a second water pump on a second pipeline to be turned on, and the farmland is fertilized based on the second irrigation instruction; and a third determining module, which is configured to determine whether to generate a third irrigation instruction based on a level of the expected crop disease index, where the third irrigation instruction is used to control a third solenoid valve and a third water pump on a third pipeline to be turned on, and pesticide is applied to the farmland based on the third irrigation instruction.

In a third aspect, the present disclosure provides a computer device, including a memory, a processor, and a computer program stored in the memory and executable on the processor, where the processor executes the computer program to implement steps of the agricultural irrigation method described in any one of the above.

In a fourth aspect, the present disclosure provides a computer-readable storage medium, on which a computer program is stored, where the computer program, when executed by a processor, implements steps of the agricultural irrigation method described in any one of the above.

In a fifth aspect, the present disclosure provides a computer program product including a computer program, where the computer program, when executed by a processor, implements steps of the agricultural irrigation method described in any one of the above.

### BRIEF DESCRIPTION OF THE DRAWINGS

FIG. 1 is a schematic flow diagram of an agricultural irrigation method according to an embodiment of the present disclosure.

FIG. 2 is a schematic diagram of a functional module of an agricultural irrigation system according to an embodiment of the present disclosure.

FIG. 3 is a schematic diagram of a structure of a computer device according to an embodiment of the present disclosure.

### DETAILED DESCRIPTION OF THE EMBODIMENTS

The technical solutions in the embodiment of the present disclosure will be clearly and completely described with reference to the drawings in the embodiment of the present disclosure hereinafter. Obviously, the described embodiments are only some of the embodiments of the present disclosure, rather than all of the embodiments. Based on the embodiments in the present disclosure, all other embodiments obtained by those skilled in the art without creative labor belong to the protection scope of the present disclosure.

To make the above objective, features and advantages of the present disclosure more obvious and understandable, the present disclosure will be further described in detail with reference to the drawings and the specific embodiments.

Agricultural irrigation refers to an agricultural activity that artificially provides water to crops to meet growth requirements of the crops. First, farmers need to observe growth situation of crops and determine whether irrigation is needed. Then, water is introduced into fields through diversion canals, pipelines or other irrigation facilities. In the fields, water may flow along pre-designed irrigation canals and be evenly distributed to roots of crops. The roots of crops absorb water, thereby obtaining water needed for growth to promote healthy growth. When farmers determine that an irrigation amount is enough through observation, they turn off the water source to stop irrigation. Therefore, in the conventional agricultural irrigation process, the level of artificial participation is high, and the degree of automation is relatively low.

At the same time, in the process of agricultural production, fertilization is also an important link. Because different plots have different soil types, fertility conditions and crop types, the amount of fertilizer needed may be different. However, in the conventional agriculture, fertilization often depends on experience and subjective judgment of farmers, which often leads to the problem of insufficient or excessive fertilization. Insufficient fertilization may lead to the lack of necessary nutrition for crops and affect the growth and development. However, excessive fertilization is not only a waste of resources, but also may pollute soil and environment. In addition, artificial fertilization also requires a lot of manpower, resulting in low efficiency and unsatisfactory results.

In other aspects of agricultural production, such as disease and pest control, a conventional method also depends on artificial real-time observation and treatment. For example, downy mildew is a common crop disease, which may cause serious damage to leaves of crops. In order to effectively control the downy mildew, farmers need to check fields regularly. Once signs of diseases are found, measures, such as spraying corresponding pesticide, must be taken in time. Such artificial observation and pesticide application treatment is not only time-consuming and labor-intensive, but also requires farmers to have specific professional knowledge and experience to ensure the control effect. However, due to the uneven knowledge level and experience of farmers, it is often difficult to achieve the optimal control effect of diseases and pests.

In the agricultural irrigation method provided by the embodiment of the present disclosure, a terminal communicates with a server through an edge. A data storage system can store data that the server needs to process. The data storage system can be arranged separately, integrated on the server, or placed on the cloud or other servers. The terminal can send a farmland condition data set to be processed to the server via the edge. After the server receives the farmland condition data set to be processed, for the farmland condition data set to be processed, the server determines whether to generate a first irrigation instruction based on a comparison result between the minimum soil water content data and farmland water-holding capacity data, determines whether to generate a second irrigation instruction based on a comparison result between the soil nutrient data and preset nutrient data, and determines whether to generate a third irrigation instruction based on a level of the expected crop disease index. The server can feed back the first irrigation instruction, the second irrigation instruction, and the third irrigation instruction, that have been obtained, to the terminal via the edge. In addition, in some embodiments, the agricultural irrigation method can also be implemented by the server or the edge separately. For example, the edge can directly process the farmland condition data set to be processed, or the server can acquire the farmland condition data set to be processed from the data storage system and process the farmland condition data set to be processed.

The terminal may be but not limited to various desktop computers, notebook computers, smart phones, tablet computers, Internet of Things devices, and portable wearable devices. The Internet of Things devices may be smart speakers, smart TVs, smart air conditioners, smart vehicle-mounted devices, and the like. The portable wearable devices may be smart watches, smart bracelets, headset devices, and the like. In the present disclosure, the terminal can further include various sensors, water pumps, water valves, and the like. The server 104 can be implemented by an independent server or a server cluster including multiple servers, and can also be a cloud server or a cloud.

The embodiment of the present disclosure can use an agricultural irrigation method based on a cloud-edge-terminal. The cloud-edge-terminal refers to three levels involved in a cloud computing architecture: a cloud, an edge, and a terminal. A hierarchical architecture is formed among the three levels to meet requirements of computing, storage and processing in different application scenarios.

The cloud usually refers to a conventional cloud computing center, which usually includes huge data centers having powerful computing capacity and storage capacity, and being able to provide users with various cloud services. In the cloud, data is stored and processed centrally, and users can easily access these services through the Internet, including but not limited to cloud storage, cloud computing, artificial intelligence, and the like. In the present disclosure, the cloud can specifically refer to onenet cloud platform, which is mainly configured to receive the processed data from a main control board and display these data. In addition, the onenet cloud platform also has a function of issuing a start command, so as to achieve remote control of a related device or system.

The edge refers to a layer between the cloud and the terminal device, which is closer to users. Usually, the edge refers to the edge server or device close to a data generation source. These edge devices have computing capacity and storage capacity, and can perform some processing and analysis work where the data is generated. In this way, it is not necessary to transmit all data to the cloud or terminal device, thereby reducing the delay time of data transmission and effectively alleviating the problem of network congestion. In this way, the edge not only improves the efficiency of data processing, but also optimizes the performance of the entire network. In the present disclosure, the edge refers to the main control board, which has two main functions: one function is to process and then upload the sensor data, that is, the farmland condition data of the area to be irrigated, to the cloud platform; and the other function is to accept the irrigation instructions issued by the cloud platform, and analyze and then issue the irrigation instructions to the terminal.

The edge refers to the main control board in the present disclosure. First, one of the main functions of the edge is to process data from sensors and upload these data to the cloud platform. In this process, the edge may preliminarily analyze and sort out the information collected by the sensor to ensure accuracy and integrity of the data. Once the data has been processed, the edge may send the data to the cloud platform through a reliable communication method, such as 4G network. In addition, the edge is also responsible for receiving instructions and commands from the cloud platform, and transmitting these instructions to various terminal devices through a Long Range Radio (LORA) networking technology to ensure the coordinated operation of the entire system. On the other hand, the edge also has the functions of real-time monitoring and automatic control. The edge may constantly compare the data collected by the sensor with a preset threshold. If the detected data exceeds a set threshold, the edge may immediately generate a corresponding control command according to the comparison result.

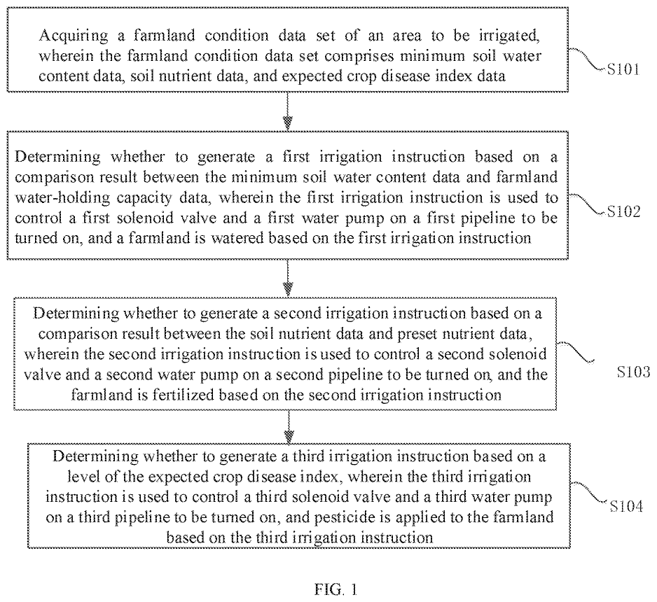

In an exemplary embodiment, as shown in FIG. 1, an agricultural irrigation method is provided. The method is executed by a computer device, and specifically, may be executed by a computer device such as a terminal or a server separately, or may be executed jointly by the terminal and the server. In the embodiment of the present disclosure, the application of the method to the cloud-edge-terminal is taken as an example for description, including the following steps 101 to 104.

Step 101: a farmland condition data set of an area to be irrigated is acquired, where the farmland condition data set includes minimum soil water content data, soil nutrient data, and expected crop disease index data.

Specifically, in order to effectively perform farmland irrigation management, it is necessary to acquire a farmland condition data set of an area to be irrigated. The data set contains a number of key information to ensure that the present condition of a farmland can be comprehensively known. First, the minimum soil water content data can help know the water content in the soil, thereby determining whether the farmland needs to be watered and determining the watering amount. Second, soil nutrient data can provide information about the content of various nutrients in the soil, thereby supplementing the missing nutrients in time to ensure healthy growth of crops. Finally, the expected crop disease index data is used to find and deal with diseases and pests in a farmland in time to prevent crops from being damaged. By taking into account these data comprehensively, a more scientific and reasonable irrigation plan can be made, thereby improving the farmland production efficiency and the crop yields.

Step 102: it is determined whether to generate a first irrigation instruction based on a comparison result between the minimum soil water content data and farmland water-holding capacity data, where the first irrigation instruction is used to control a first solenoid valve and a first water pump on a first pipeline to be turned on, and a farmland is watered based on the first irrigation instruction.

“It is determined whether to generate a first irrigation instruction based on a comparison result between the minimum soil water content data and farmland water-holding capacity data” in Step 102 includes the following sub-steps A1 to A4:
A1: calculating reference crop evapotranspiration;
A2: calculating a crop water requirement according to the reference crop evapotranspiration:
A3: calculating a minimum soil water content based on an initial soil water content and the crop water requirement; and
A4: comparing the minimum soil water content with a preset content of the farmland water-holding capacity, and generating the first irrigation instruction if the minimum soil water content is less than a preset percentage of the farmland water-holding capacity.

Specifically, the reference crop evapotranspiration is calculated first, and the calculation formula is as follows:

$${ET}_{0} = \frac{0.408 Δ R + γ \frac{900}{T + 273} U ( {e}_{1} - {e}_{2} )}{Δ + γ ( 1 + 0.34 U )} ;$$

where ET₀ denotes the reference crop evapotranspiration, R denotes a net radiation flux on the surface, T denotes an average temperature, e₁ denotes a saturated water vapor pressure value, e₂ denotes an actual water vapor pressure value, U denotes a wind speed, γ denotes a psychrometric constant, and Δ denotes a curve slope of the saturated water vapor pressure and temperature.

The crop water requirement is calculated according to the reference crop evapotranspiration, and the calculation formula of the crop water requirement is as follows:

$$ET = K \cdot {ET}_{0} ;$$

where ET denotes a crop water requirement, and K denotes a crop coefficient.

The minimum soil water content is calculated according to the initial soil water requirement and the crop water requirement, and the calculation formula of the minimum soil water content is as follows:

$${W}_{min} = {W}_{0} - ET ;$$

where Wₘᵢₙ denotes a minimum soil water content, and W₀ denotes an initial soil water requirement.

For example, Wₘᵢₙ is compared with 60% of the farmland water-holding capacity F. If Wₘᵢₙ is less than 60% of F, the farmland needs to be irrigated.

In a feasible manner, the first irrigation instruction further includes an irrigation quota.

Specifically, based on the initial soil water content, the current soil water content, the rainfall within a preset number of days, and the reference crop evapotranspiration, the irrigation quota is calculated, and the watering amount is determined according to the irrigation quota. The calculation formula of the irrigation quota is as follows:

$$M = {W}_{t} - {W}_{0} - P + ET ;$$

where M denotes the irrigation quota, Wₜ denotes a current soil water content, W₀ denotes an initial soil water content, P denotes the rainfall within a preset number of days, and ET denotes a crop water requirement.

In a feasible manner, the reference crop evapotranspiration is acquired through a weather station. The initial soil water content and the current soil water content are acquired by a soil moisture sensor. The rainfall within a preset number of days is acquired by a rain gauge.

It can be understood that the reference crop evapotranspiration is an important benchmark for evaluating the crop water requirement, the calculation of which depends on a series of meteorological data provided by a weather station. These data include but are not limited to the daily maximum temperature, the daily minimum temperature, the relative humidity, the sunshine duration, the wind speed, and the like. Modern weather stations can collect these meteorological elements in real time by using a sensor technology and a data processing system. The soil water content is another key index to evaluate soil moisture conditions and guide irrigation decisions. Both the initial soil water content (that is, the soil water content before irrigation) and the current soil water content (that is, the real-time water content during irrigation) can be measured by the soil moisture sensor. These sensors indirectly calculate the water content in soil by measuring the physical properties of soil such as the electrical conductivity and the dielectric constant. Different types of soil moisture sensors (such as a Time Domain Reflectometer (TDR) and a Frequency Domain Reflectometer (FDR)) are suitable for different soil types and monitoring requirements. In field practice, a soil moisture sensor is usually installed in a key area of crop root distribution to acquire the most accurate soil moisture information. The sensor sends the monitored data to the terminal or the agricultural management system in real time through the wireless transmission technology, so as to know the dynamic change of soil moisture at any time. The rainfall is one of the important natural factors affecting agricultural production. Rainfall within a preset number of days is mainly predicted and monitored through a rainfall sensor.

For example, a water receiver of the rain gauge is configured to collect rainwater, which is usually located at the top of the sensor and is designed to effectively guide the rainwater into the sensor. The collected rainwater may then flow into an upper cylinder which usually has a funnel shape to concentrate the rainwater and then guide to a metering tipping bucket. The metering tipping bucket has two semi-conical chambers with an equal volume, which are separated by a middle partition. One chamber is in the working state of receiving water, while the other chamber is in the waiting state. When rainwater begins to flow into one of the chambers, is gradually accumulated, and reaches a predetermined volume value, which is usually 0.5 mm of rainfall, the chamber may turn over to the other side due to an action of gravity, thereby changing from the water receiving working state to the waiting state. At the same time, the other chamber that was originally in the waiting state begins to receive water. The turning action is performed continuously. After one chamber is filled with a predetermined volume of rain, the chamber may turn over, while the other chamber starts to work, repeating the cycle continuously. A magnetic steel is installed on a side wall of the tipping bucket. The magnetic steel may move when the tipping bucket turns over. The movement of the magnetic steel can be detected through a dry reed tube. Whenever the magnetic steel passes the dry reed tube, the on-off change of the reed tube can be caused, thereby generating a pulse signal. The pulse signal may then be converted into a digital signal, which is output usually in the form of 485 communication protocol, so as to facilitate data transmission and recording.

In order to acquire soil moisture data through a soil moisture sensor, it is necessary to select a suitable soil moisture sensor and install the soil moisture sensor in the corresponding position of the area to be irrigated. These sensors should be high in accuracy and stability to ensure reliability of data. During installation, it should be ensured that probe parts of the sensors are completely inserted into soil, and the positions thereof are evenly distributed so as to comprehensively cover the entire irrigation area. The soil moisture sensor is connected to a data collector, and the data collector is connected to the LORA communication module. Then, the parameters of the data collector are configured, that is, the appropriate sampling frequency and the data recording interval are set. The sampling frequency should be adjusted according to the actual requirements and sensor performance to ensure that the change of soil moisture can be captured in time. The data recording interval should be set according to the irrigation requirements and the management strategy. The STH20 temperature and humidity sensor may be selected as the foregoing soil moisture sensor.

It can be understood that the soil moisture sensor is started to monitor the soil moisture in real time. In the process of monitoring, the operating state of the system is checked regularly to ensure accuracy of data transmission and recording. If necessary, on-site calibration and maintenance are performed to ensure reliability of data. The soil moisture data is acquired through the data collector to monitor the water content in the soil, and then transmitted to the cloud platform for analysis and processing. Special software or applications, such as Tableau or Power BI, can be used to visualize the data, that is, to convert the data into a chart type, so as to better understand the changing trend and distribution of soil moisture.

Step 103: it is determined whether to generate a second irrigation instruction based on a comparison result between the soil nutrient data and preset nutrient data, where the second irrigation instruction is used to control a second solenoid valve and a second water pump on a second pipeline to be turned on, and the farmland is fertilized based on the second irrigation instruction.

Specifically, “it is determined whether to generate a second irrigation instruction based on a comparison result between the soil nutrient data and preset nutrient data” in Step 103 includes the following sub-steps B1 to B3.
B1: an actual soil nutrient content data in a farmland is acquired.

Specifically, the actual nutrient data should include but not limited to the concentrations of nitrogen, phosphorus, potassium and other important trace elements.
B2: the preset nutrient data is set based on the crop requirements and the expected crop yields.
B3: the soil nutrient data is compared with the preset nutrient data, and if the soil nutrient data is less than the preset nutrient data, a second irrigation instruction is generated.

In a feasible manner, the second irrigation instruction further includes the amount of fertilization.

For each required nutrient element, a nutrient difference is calculated by the following formula:

Δ nutrient=a preset nutrient content−an actual nutrient content.

For example, for each nutrient that needs to be supplemented, the required amount of fertilization is calculated according to the difference. Assuming that the total amount of the nutrient that needs to be supplemented is ΔX, and the percentage content of this nutrient in the fertilizer is P %, the weight W of the required fertilizer can be calculated by the following formula:

$$W = \frac{Δ X}{P \%} .$$

Specifically, the contents of key nutrients such as nitrogen, phosphorus and potassium in soil are continuously monitored by soil nutrient sensors. Through the foregoing real-time data, the nutrient conditions of soil can be comprehensively known, avoiding the uncertainty of conventional experience-based judgment, ensuring that each land can obtain the most reasonable nutrient supplement to avoid resource waste. The soil nutrient sensors are deployed in the area to be irrigated, and the nutrient data in the soil is acquired in real time. According to the topography and the soil type of the area to be irrigated, the sensors are evenly distributed in different positions, thereby ensuring that the acquired data is representative and can comprehensively reflect the soil nutrient conditions of the entire area.

It can be understood that the soil nutrient sensors are installed in the soil near roots of crops, and the depth is generally between 10 cm and 20 cm. A data transmission line of a soil nutrient sensor is connected or an LORA communication module is configured to ensure that data can be transmitted to the cloud platform. Then, according to the actual requirements, the frequency of collecting data is set, and the time interval of the soil nutrient sensor for collecting data, such as once every hour or once a day, is set, so as to monitor the change of soil nutrients in real time and adjust a fertilization method in time. Finally, a data management system is established. The collected soil nutrient data is transmitted to the cloud platform for storage, analysis, and visual display. Through data analysis, the changing trend of soil nutrients is known. In addition, a soil structure can be better protected, and soil degradation and pollution can be prevented.

Step 104, it is determined whether to generate a third irrigation instruction based on a level of the expected crop disease index, where the third irrigation instruction is used to control a third solenoid valve and a third water pump on a third pipeline to be turned on, and pesticide is applied to the farmland based on the third irrigation instruction.

Specifically, “it is determined whether to generate a third irrigation instruction based on a level of the expected crop disease index” in Step 104 includes the following sub-steps C1 to C3:
C1: acquiring a daily average temperature, an accumulated rainfall, a daily average relative humidity, and the accumulated number of rainy days within a preset time period, where the daily average temperature and the daily average relative humidity are acquired through a thermometer screen, and the accumulated rainfall and the accumulated number of rainy days are acquired through a rain gauge;
C2: obtaining the expected crop disease index based on the daily average temperature, the accumulated rainfall, the daily average relative humidity, and the accumulated number of rainy days; and
C3: generating the third irrigation instruction when the expected crop disease index is greater than or equal to level 3.

For example, a regression equation is established with a grape downy mildew disease index as a dependent variable and a related meteorological factor as an independent variable:

$$Y = 47.98 - 1.51 X 1 + 0.35 X 2 - 0.12 X 3 - 0.86 X 4 ;$$

where Y is the expected crop disease index, X1 is the daily average temperature in the first seven days, X2 is the accumulated rainfall in the first seven days, X3 is the daily average relative humidity in the first seven days, and X4 is the accumulated number of rainy days in the first seven days. The daily average temperature and the daily average relative humidity are acquired through the thermometer screen, and the values of the accumulated rainfall and the accumulated number of rainy days are acquired through the rain gauge. The distribution table of the expected crop disease index is shown in Table 1:

TABLE 1

| Occurrence Level | 1 | 2 | 3 | 4 | 5 |
|---|---|---|---|---|---|
| Occurrence Degree | Mild | Moderate | Moderate | Moderate | Severe |
| | | to mild | | to severe | |
| Expected disease | ≤1.0 | 1~17 | 17~34 | 34~50 | >50 |
| index | | | | | |

In view of the severity of the grape downy mildew, it is necessary to take corresponding pesticide treatment measures. When the expected disease index reaches or exceeds level 3, it is necessary to start the third irrigation instruction. This instruction includes both the irrigation operation and the amount of pesticide applied.

For example, for the grape downy mildew, the main chemicals used are as follows: 150 to 200 times of diluted half-dose/equal-dose Bordeaux mixture, 500 to 700 times of diluted 70% propineb (Antracol) wettable powder, 600 to 800 times of diluted 80% mancozeb (Mancozeb) wettable powder, 500 to 600 times of diluted 78% Bordeaux mixture+mancozeb (Mancozeb and Bordeaux mixture) wettable powder, and the like. The amount of pesticide applied can be adjusted according to the severity of the disease index.

In a feasible manner, the first irrigation instruction is used to control the first solenoid valve and the first water pump to be turned on by sequentially starting a first solenoid valve relay and a first water pump relay, and water the area to be irrigated by sequentially turning on the first solenoid valve and the first water pump. A first flowmeter is arranged in the first pipeline. When statistical data of the first flowmeter is greater than or equal to first preset flow data, a first turn-off instruction is generated to sequentially turn off the first water pump relay and the first solenoid valve relay.

Specifically, the main function of the first irrigation instruction is to start two key components: the first solenoid valve relay and the first water pump relay. The first solenoid valve relay is responsible for controlling the ON and OFF state of the first solenoid valve, and the first water pump relay is responsible for controlling the ON and OFF state of the first water pump. In order to protect a water pipe, it is necessary to turn on the first solenoid valve relay before turning on the first water pump relay. Through the cooperative work of these two relays, the farmland can be accurately irrigated. After the first solenoid valve and the first water pump are turned on sequentially, the water in a water tank will flow to a main pipeline through the first pipeline connected with the two relays, and then to the farmland to be irrigated through the main pipeline, so as to water the farmland. This process ensures that the farmland can obtain proper water supply according to the actual soil moisture requirements, thereby maintaining the healthy growth of crops.

A flowmeter device is installed in the first pipeline. When the real-time flow data detected by the flowmeter is accumulated to some extent, and reaches or exceeds the first preset flow data, the first preset flow data is the irrigation quota that is contained in the first irrigation instruction. The edge compares the real-time flow data with the preset flow data. When the real-time flow data is greater than the preset flow data, the edge sends a first turn-off instruction to a control unit. The first turn-off instruction activates the first water pump relay and the first solenoid valve relay sequentially, and the first water pump relay may control the first water pump to stop operation. Then, the first solenoid valve relay is responsible for driving and controlling the first solenoid valve to perform a turn-off action. In this way, the system can quickly respond to excessive flow conditions, thereby preventing potential pipeline rupture, leakage or other potential hazards, and ensuring safety and stability of the entire pipeline system.

In a feasible manner, the second irrigation instruction is used to control the second solenoid valve and the second water pump to be turned on by sequentially starting a second solenoid valve relay and a second water pump relay, and water the area to be irrigated by sequentially turning on the second solenoid valve and the second water pump. A second flowmeter is arranged in the second pipeline. When statistical data of the second flowmeter is greater than or equal to second preset flow data, a second turn-off instruction is generated to sequentially turn off the second water pump relay and the second solenoid valve relay.

Specifically, the main function of the second irrigation instruction is to start two key components: the second solenoid valve relay and the second water pump relay. The second solenoid valve relay is responsible for controlling the ON and OFF state of the second solenoid valve, and the second water pump relay is responsible for controlling the ON and OFF state of the second water pump. In order to protect a water pipe, it is necessary to turn on the second solenoid valve relay before turning on the second water pump relay. Through the cooperative work of these two relays, the farmland can be accurately fertilized. After the second solenoid valve and the second water pump are turned on sequentially, the fertilizer in a fertilizer liquid tank will flow to the main pipeline through the second pipeline connected with the two relays, and then to the farmland to be irrigated through the main pipeline, so as to fertilize the farmland.

A flowmeter device is installed in the second pipeline to monitor and record the flow of fluid passing through the pipeline in real time. When the real-time flow data detected by the flowmeter is accumulated to some extent, and reaches or exceeds the second preset flow data, the second preset flow data is the amount of fertilization that is contained in the second irrigation instruction. The edge compares the real-time flow data with the preset flow data. When the real-time flow data is greater than the preset flow data, the edge sends a second turn-off instruction to a control unit. The second turn-off instruction activates the second water pump relay and the second solenoid valve relay sequentially, and the second water pump relay may control the second water pump to stop operation. Then, the second solenoid valve relay is responsible for driving and controlling the second solenoid valve to perform a turn-off action. In this way, the system can quickly respond to excessive flow conditions, thereby preventing potential pipeline rupture, leakage or other potential hazards, and ensuring safety and stability of the entire pipeline system.

In a feasible manner, the third irrigation instruction is used to control the third solenoid valve and the third water pump to be turned on by sequentially starting a third solenoid valve relay and a third water pump relay, and water the area to be irrigated by turning on the third solenoid valve and the third water pump. A third flowmeter is arranged in the third pipeline. When statistical data of the third flowmeter is greater than or equal to third preset flow data, a third turn-off instruction is generated to sequentially turn off the third water pump relay and the third solenoid valve relay.

Specifically, the main function of the third irrigation instruction is to start two key components: the third solenoid valve relay and the third water pump relay. The third solenoid valve relay is responsible for controlling the ON and OFF state of the third solenoid valve, and the third water pump relay is responsible for controlling the ON and OFF state of the third water pump. In order to protect a water pipe, it is necessary to turn on the third solenoid valve relay before turning on the third water pump relay. Through the cooperative work of these two relays, the farmland can be accurately irrigated. After the third solenoid valve and the third water pump are turned on sequentially, the water source in a water tank will flow to the main pipeline through the third pipeline connected with the two relays, and then to the farmland to be irrigated through the main pipeline, so as to water the farmland. This process ensures that the farmland can obtain proper water supply according to the actual soil moisture requirements, thereby maintaining the healthy growth of crops.

A flowmeter device is installed in the third pipeline to monitor and record the flow of fluid passing through the pipeline in real time. When the real-time flow data detected by the flowmeter is accumulated to some extent, and reaches or exceeds the third preset flow data, the third preset flow data is the amount of pesticide applied that is contained in the third irrigation instruction. When the real-time flow data is greater than the preset flow data, the edge sends a third turn-off instruction to a control unit. The third turn-off instruction activates the third water pump relay and the third solenoid valve relay sequentially, and the third water pump relay may control the third water pump to stop operation. Then, the third solenoid valve relay is responsible for driving and controlling the third solenoid valve to perform a turn-off action. In this way, the system can quickly respond to excessive flow conditions, thereby preventing potential pipeline rupture, leakage or other potential hazards, and ensuring safety and stability of the entire pipeline system.

For example, TAS-LORA-181 wireless data transmission station can be selected as the LORA communication module. YF-S201 flowmeter can be selected as the first flowmeter, the second flowmeter, and the third flowmeter. The YF-S201 flowmeter is connected with the LORA communication module. The flowmeter data is uploaded to the main control board through the LORA communication module. The main control board compares the flowmeter data with the preset data, and decides whether to issue the turn-off instruction to the irrigation module according to the comparison result. In addition, the main control board uploads the flowmeter data to the cloud platform by using a 4g module.

In a feasible manner, in the process of irrigating the farmland in the area to be irrigated, if the pressure in the first pipeline, the second pipeline or the third pipeline is greater than the preset water flow pressure, the corresponding water pump relay is turned off. The pressures in the pipelines are measured by pressure sensors. The pressure sensors can be selected as but is not limited to HK1100C pressure sensor. The pressure sensor is connected with a 4g communication module. The pressure data is transmitted to the cloud platform through the 4g communication module.

In a feasible manner, water hammer absorbers are arranged in the first pipeline, the second pipeline, and the third pipeline, respectively.

Specifically, these water hammer absorbers are configured to absorb and alleviate the resulting pressure fluctuation when the water flow suddenly stops or changes directions, thereby effectively preventing a water hammer phenomenon. In this way, the pipeline can be further protected from damage, and the service life of the pipeline can be prolonged. The type of water hammer absorbers can be selected according to actual requirements. For example, 9000× water hammer absorber can be selected.

Based on the same inventive concept, the embodiment of the present disclosure further provides an agricultural irrigation system for implementing the foregoing agricultural irrigation method. The implementation solution provided by the system is similar to the implementation solution described in the foregoing method. Therefore, for the specific definition of one or more embodiments of the agricultural irrigation system provided below, refer to the foregoing definition of the agricultural irrigation method, which will not be described in detail here.

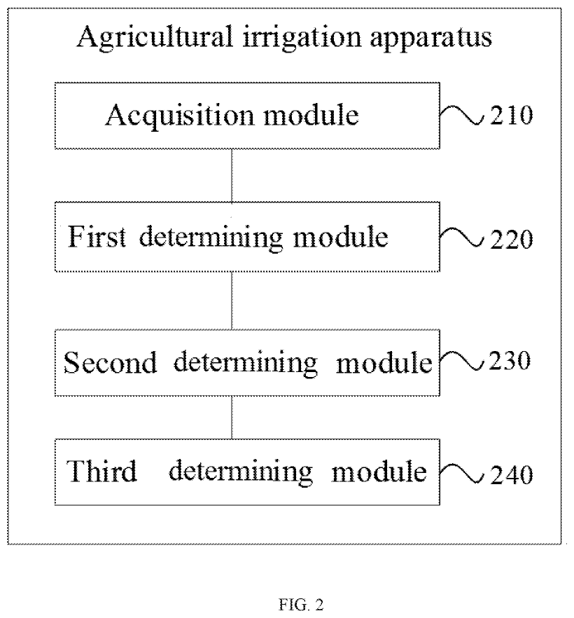

In an exemplary embodiment, as shown in FIG. 2, an agricultural irrigation system is provided, including:
an acquisition module, which is configured to acquire a farmland condition data set of an area to be irrigated, where the farmland condition data set includes minimum soil water content data, soil nutrient data, and expected crop disease index data;
a first determining module, which is configured to determine whether to generate a first irrigation instruction based on a comparison result between the minimum soil water content data and farmland water-holding capacity data, where the first irrigation instruction is used to control a first solenoid valve and a first water pump on a first pipeline to be turned on, and a farmland is watered based on the first irrigation instruction;
a second determining module, which is configured to determine whether to generate a second irrigation instruction based on a comparison result between the soil nutrient data and preset nutrient data, where the second irrigation instruction is used to control a second solenoid valve and a second water pump on a second pipeline to be turned on, and the farmland is fertilized based on the second irrigation instruction; and
a third determining module, which is configured to determine whether to generate a third irrigation instruction based on a level of the expected crop disease index, where the third irrigation instruction is used to control a third solenoid valve and a third water pump on a third pipeline to be turned on, and pesticide is applied to the farmland based on the third irrigation instruction.

As an optional embodiment, the first determining module is specifically configured to:
calculate reference crop evapotranspiration;
calculate a crop water requirement according to the reference crop evapotranspiration;
calculate a minimum soil water content based on an initial soil water content and the crop water requirement; and
compare the minimum soil water content with a preset content of the farmland water-holding capacity, and generate the first irrigation instruction if the minimum soil water content is less than a preset percentage of the farmland water-holding capacity.

As an optional embodiment, the third determining module is specifically configured to:
acquire a daily average temperature, an accumulated rainfall, a daily average relative humidity, and the accumulated number of rainy days within a preset time period, where the daily average temperature and the daily average relative humidity are acquired through a thermometer screen, and the accumulated rainfall and the accumulated number of rainy days are acquired through a rain gauge;
obtain the expected crop disease index based on the daily average temperature, the accumulated rainfall, the daily average relative humidity, and the accumulated number of rainy days; and
generate the third irrigation instruction when the expected crop disease index is greater than or equal to level 3.

As an optional embodiment, the agricultural irrigation system further includes:
in a process of watering the farmland in the area to be irrigated, turning off the first water pump relay and turning on the first solenoid valve relay if a pressure in a watering pipeline is greater than a preset water flow pressure.

As an optional embodiment, in the agricultural irrigation system:
the first irrigation instruction is used to control the first solenoid valve and the first water pump to be turned on by sequentially starting a first solenoid valve relay and a first water pump relay, and water the area to be irrigated by turning on the first solenoid valve and the first water pump;
the second irrigation instruction is used to control the second solenoid valve and the second water pump to be turned on by sequentially starting a second solenoid valve relay and a second water pump relay, and fertilize the area to be irrigated by turning on the second solenoid valve and the second water pump; and
the third irrigation instruction is used to control the third solenoid valve and the third water pump to be turned on by sequentially starting a third solenoid valve relay and a third water pump relay, and apply pesticide to the area to be irrigated by turning on the third solenoid valve and the third water pump.

As an optional embodiment, in the agricultural irrigation system:
a first flowmeter is arranged in the first pipeline, and when statistical data of the first flowmeter is greater than or equal to first preset flow data, a first turn-off instruction is generated to sequentially turn off the first water pump relay and the first solenoid valve relay;
a second flowmeter is arranged in the second pipeline, and when statistical data of the second flowmeter is greater than or equal to second preset flow data, a second turn-off instruction is generated to sequentially turn off the second water pump relay and the second solenoid valve relay; and
a third flowmeter is arranged in the third pipeline, and when statistical data of the third flowmeter is greater than or equal to third preset flow data, a third turn-off instruction is generated to sequentially turn off the third water pump relay and the third solenoid valve relay.

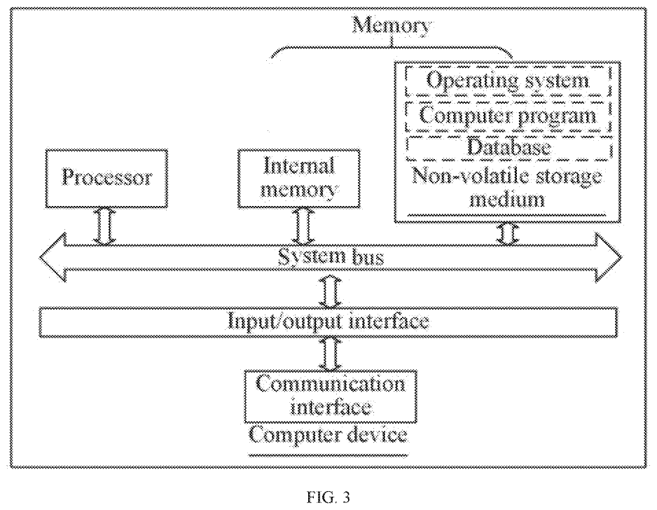

In an exemplary embodiment, a computer device is provided. The computer device may be a server or a terminal, and the internal structure diagram may be as shown in FIG. 3. The computer device includes a processor, a memory, an Input/Output interface (I/O for short) and a communication interface. The processor, the memory and the input/output interface are connected through the system bus, and the communication interface is connected to the system bus through the input/output interface. The processor of the computer device is configured to provide computing and control capabilities. The memory of the computer device includes a non-volatile storage medium and an internal memory. The non-volatile storage medium stores an operating system, a computer program and a database. The internal memory provides an environment for the operation of the operating system and the computer program in the non-volatile storage medium. The database of the computer device is configured to store the farmland condition data set of the area to be irrigated. The input/output interface of the computer device is configured to exchange information between the processor and an external device. The communication interface of the computer device is configured to communicate with an external terminal through network connection. The computer program, when executed by a processor, implements an agricultural irrigation method.

It can be understood by those skilled in the art that the structure shown in FIG. 3 is only a block diagram of a part of the structure related to the solution of the present disclosure, and does not constitute a limitation on the computer device to which the solution of the present disclosure is applied. The specific computer device may include more or less components than those shown in the figure, or combine some components, or have different component arrangements.

In an exemplary embodiment, a computer device is further provided, including a memory and a processor. A computer program is stored in the memory. The processor, when executing the computer program, implements steps in the above method embodiments.

In an exemplary embodiment, a computer-readable storage medium is provided, on which a computer program is stored. The computer program, when executed by a processor, implements the steps in the above method embodiments.

In an exemplary embodiment, a computer program product is provided, including a computer program. The computer program, when executed by a processor, implements the steps in the above method embodiments.

It should be noted that the user information (including but not limited to user equipment information, user personal information, etc.) and data (including but not limited to data for analysis, stored data, displayed data, etc.) involved in the present disclosure are all information and data authorized by users or fully authorized by all parties, and the collection, use and processing of relevant data must comply with relevant regulations.

Those skilled in the art can understand that all or part of the processes in the method of the above-mentioned embodiments can be completed by instructing relevant hardware through a computer program. The computer program can be stored in a non-volatile computer-readable storage medium. The computer program, when executed, can include the processes of the embodiments of each of the above-mentioned methods. Any reference to the memory, the database or other media used in each of the embodiments provided by the present disclosure may include at least one of a non-volatile memory and a volatile memory. The non-volatile memory may include a Read-Only Memory (ROM), a magnetic tape, a floppy disk, a flash memory, an optical memory, a high-density embedded non-volatile memory, a Resistive Random Access Memory (ReRAM), a Magneto-Resistive Random Access Memory (MRAM), a Ferroelectric Random Access Memory (FRAM), a Phase Change Memory (PCM), a graphene memory, and the like. The volatile memory may include a Random Access Memory (RAM) or an external cache memory. By way of illustration and not limitation, the RAM can be in various forms, such as a Static Random Access Memory (SRAM) or a Dynamic Random Access Memory (DRAM).

The database involved in various embodiments provided by the present disclosure may include at least one of a relational database and a non-relational database. The non-relational database may include, but is not limited to, a distributed database based on a block chain. The processor involved in the embodiments provided by the present disclosure may include, but is not limited to, a general processor, a central processing unit, a graphics processing unit, a digital signal processor, a programmable logic device, a data processing logic device based on quantum computing, and the like.

Each of the technical features of the above embodiments can be combined at will. In order to make the description concise, not all possible combinations of the technical features in the above embodiments are described. However, as long as there is no contradiction between the combinations of these technical features, the combinations should be considered as the scope recorded in this specification.

In the present disclosure, specific examples are used to explain the principle and implementation of the present disclosure. The description of the above embodiments is only used to help understand the method and the core idea of the present disclosure. At the same time, for those skilled in the art, according to the idea of the present disclosure, there will be changes in the specific implementation and the application scope. To sum up, the contents of this specification should not be construed as limiting the present disclosure.

What is claimed is:

1. An agricultural irrigation method, comprising:
acquiring a farmland condition data set of an area to be irrigated, wherein the farmland condition data set comprises minimum soil water content data, soil nutrient data, and expected crop disease index data;
determining whether to generate a first irrigation instruction based on a comparison result between the minimum soil water content data and farmland water-holding capacity data, wherein the first irrigation instruction is used to control a first solenoid valve and a first water pump on a first pipeline to be turned on, and a farmland is watered based on the first irrigation instruction;
determining whether to generate a second irrigation instruction based on a comparison result between the soil nutrient data and preset nutrient data, wherein the second irrigation instruction is used to control a second solenoid valve and a second water pump on a second pipeline to be turned on, and the farmland is fertilized based on the second irrigation instruction; and
determining whether to generate a third irrigation instruction based on a level of the expected crop disease index, wherein the third irrigation instruction is used to control a third solenoid valve and a third water pump on a third pipeline to be turned on, and pesticide is applied to the farmland based on the third irrigation instruction.

2. The agricultural irrigation method according to claim 1, wherein determining whether to generate the first irrigation instruction based on the comparison result between the minimum soil water content data and farmland water-holding capacity data comprises:
calculating reference crop evapotranspiration;
calculating a crop water requirement according to the reference crop evapotranspiration;
calculating a minimum soil water content based on an initial soil water content and the crop water requirement; and
comparing the minimum soil water content with a preset content of the farmland water-holding capacity, and generating the first irrigation instruction in response to the minimum soil water content being less than a preset percentage of the farmland water-holding capacity.

3. The agricultural irrigation method according to claim 2, wherein the reference crop evapotranspiration is acquired by a weather station, and the initial soil water content is acquired by a soil moisture sensor.

4. The agricultural irrigation method according to claim 1, wherein determining whether to generate the third irrigation instruction based on the level of the expected crop disease index comprises:
acquiring a daily average temperature, an accumulated rainfall, a daily average relative humidity, and an accumulated number of rainy days within a preset time period, wherein the daily average temperature and the daily average relative humidity are acquired through a thermometer screen, and the accumulated rainfall and the accumulated number of rainy days are acquired through a rain gauge;
obtaining the expected crop disease index based on the daily average temperature, the accumulated rainfall, the daily average relative humidity, and the accumulated number of rainy days; and
generating the third irrigation instruction in response to the expected crop disease index being greater than or equal to level 3.

5. The agricultural irrigation method according to claim 1, wherein the first irrigation instruction is used to control the first solenoid valve and the first water pump to be turned on by sequentially starting a first solenoid valve relay and a first water pump relay, and water the area to be irrigated by turning on the first solenoid valve and the first water pump;
the second irrigation instruction is used to control the second solenoid valve and the second water pump to be turned on by sequentially starting a second solenoid valve relay and a second water pump relay, and fertilize the area to be irrigated by turning on the second solenoid valve and the second water pump; and
the third irrigation instruction is used to control the third solenoid valve and the third water pump to be turned on by sequentially starting a third solenoid valve relay and a third water pump relay, and apply pesticide to the area to be irrigated by turning on the third solenoid valve and the third water pump.

6. The agricultural irrigation method according to claim 5, wherein the agricultural irrigation method further comprises:
arranging a first flowmeter in the first pipeline, and in response to statistical data of the first flowmeter being greater than or equal to first preset flow data, generating a first turn-off instruction, wherein the first turn-off instruction is used to sequentially turn off the first water pump relay and the first solenoid valve relay;
arranging a second flowmeter in the second pipeline, and in response to statistical data of the second flowmeter being greater than or equal to second preset flow data, generating a second turn-off instruction, wherein the second turn-off instruction is used to sequentially turn off the second water pump relay and the second solenoid valve relay; and
arranging a third flowmeter in the third pipeline, and in response to statistical data of the third flowmeter being greater than or equal to third preset flow data, generating a third turn-off instruction, wherein the third turn-off instruction is used to sequentially turn off the third water pump relay and the third solenoid valve relay.

7. An agricultural irrigation system, comprising:
an acquisition module, which is configured to acquire a farmland condition data set of an area to be irrigated, wherein the farmland condition data set comprises minimum soil water content data, soil nutrient data, and expected crop disease index data;
a first determining module, which is configured to determine whether to generate a first irrigation instruction based on a comparison result between the minimum soil water content data and farmland water-holding capacity data, wherein the first irrigation instruction is used to control a first solenoid valve and a first water pump on a first pipeline to be turned on, and a farmland is watered based on the first irrigation instruction;
a second determining module, which is configured to determine whether to generate a second irrigation instruction based on a comparison result between the soil nutrient data and preset nutrient data, wherein the second irrigation instruction is used to control a second solenoid valve and a second water pump on a second pipeline to be turned on, and the farmland is fertilized based on the second irrigation instruction; and
a third determining module, which is configured to determine whether to generate a third irrigation instruction based on a level of the expected crop disease index, wherein the third irrigation instruction is used to control a third solenoid valve and a third water pump on a third pipeline to be turned on, and pesticide is applied to the farmland based on the third irrigation instruction.

8. A computer device, comprising a memory, a processor, and a computer program stored in the memory and executable on the processor, wherein the processor executes the computer program to implement steps of the agricultural irrigation method according to claim 1.

9. The computer device according to claim 8, wherein determining whether to generate the first irrigation instruction based on the comparison result between the minimum soil water content data and farmland water-holding capacity data comprises:
calculating reference crop evapotranspiration;
calculating a crop water requirement according to the reference crop evapotranspiration;
calculating a minimum soil water content based on an initial soil water content and the crop water requirement; and
comparing the minimum soil water content with a preset content of the farmland water-holding capacity, and generating the first irrigation instruction in response to the minimum soil water content being less than a preset percentage of the farmland water-holding capacity.

10. The computer device according to claim 9, wherein the reference crop evapotranspiration is acquired by a weather station, and the initial soil water content is acquired by a soil moisture sensor.

11. The computer device according to claim 8, wherein determining whether to generate the third irrigation instruction based on the level of the expected crop disease index comprises:
acquiring a daily average temperature, an accumulated rainfall, a daily average relative humidity, and an accumulated number of rainy days within a preset time period, wherein the daily average temperature and the daily average relative humidity are acquired through a thermometer screen, and the accumulated rainfall and the accumulated number of rainy days are acquired through a rain gauge;
obtaining the expected crop disease index based on the daily average temperature, the accumulated rainfall, the daily average relative humidity, and the accumulated number of rainy days; and
generating the third irrigation instruction in response to the expected crop disease index being greater than or equal to level 3.

12. The computer device according to claim 8, wherein the first irrigation instruction is used to control the first solenoid valve and the first water pump to be turned on by sequentially starting a first solenoid valve relay and a first water pump relay, and water the area to be irrigated by turning on the first solenoid valve and the first water pump;
the second irrigation instruction is used to control the second solenoid valve and the second water pump to be turned on by sequentially starting a second solenoid valve relay and a second water pump relay, and fertilize the area to be irrigated by turning on the second solenoid valve and the second water pump; and
the third irrigation instruction is used to control the third solenoid valve and the third water pump to be turned on by sequentially starting a third solenoid valve relay and a third water pump relay, and apply pesticide to the area to be irrigated by turning on the third solenoid valve and the third water pump.

13. The computer device according to claim 12, wherein the agricultural irrigation method further comprises:
arranging a first flowmeter in the first pipeline, and in response to statistical data of the first flowmeter being greater than or equal to first preset flow data, generating a first turn-off instruction, wherein the first turn-off instruction is used to sequentially turn off the first water pump relay and the first solenoid valve relay;
arranging a second flowmeter in the second pipeline, and in response to statistical data of the second flowmeter being greater than or equal to second preset flow data, generating a second turn-off instruction, wherein the second turn-off instruction is used to sequentially turn off the second water pump relay and the second solenoid valve relay; and
arranging a third flowmeter in the third pipeline, and in response to statistical data of the third flowmeter being greater than or equal to third preset flow data, generating a third turn-off instruction, wherein the third turn-off instruction is used to sequentially turn off the third water pump relay and the third solenoid valve relay.

14. A non-transitory computer-readable storage medium, on which a computer program is stored, wherein the computer program, when executed by a processor, implements steps of the agricultural irrigation method according to claim 1.

15. The non-transitory computer-readable storage medium according to claim 14, wherein determining whether to generate the first irrigation instruction based on the comparison result between the minimum soil water content data and farmland water-holding capacity data comprises:
calculating reference crop evapotranspiration;
calculating a crop water requirement according to the reference crop evapotranspiration;
calculating a minimum soil water content based on an initial soil water content and the crop water requirement; and
comparing the minimum soil water content with a preset content of the farmland water-holding capacity, and generating the first irrigation instruction in response to the minimum soil water content being less than a preset percentage of the farmland water-holding capacity.

16. The non-transitory computer-readable storage medium according to claim 15, wherein the reference crop evapotranspiration is acquired by a weather station, and the initial soil water content is acquired by a soil moisture sensor.

17. The non-transitory computer-readable storage medium according to claim 14, wherein determining whether to generate the third irrigation instruction based on the level of the expected crop disease index comprises:
acquiring a daily average temperature, an accumulated rainfall, a daily average relative humidity, and an accumulated number of rainy days within a preset time period, wherein the daily average temperature and the daily average relative humidity are acquired through a thermometer screen, and the accumulated rainfall and the accumulated number of rainy days are acquired through a rain gauge;
obtaining the expected crop disease index based on the daily average temperature, the accumulated rainfall, the daily average relative humidity, and the accumulated number of rainy days; and
generating the third irrigation instruction in response to the expected crop disease index being greater than or equal to level 3.

18. The non-transitory computer-readable storage medium according to claim 14, wherein the first irrigation instruction is used to control the first solenoid valve and the first water pump to be turned on by sequentially starting a first solenoid valve relay and a first water pump relay, and water the area to be irrigated by turning on the first solenoid valve and the first water pump;
the second irrigation instruction is used to control the second solenoid valve and the second water pump to be turned on by sequentially starting a second solenoid valve relay and a second water pump relay, and fertilize the area to be irrigated by turning on the second solenoid valve and the second water pump; and
the third irrigation instruction is used to control the third solenoid valve and the third water pump to be turned on by sequentially starting a third solenoid valve relay and a third water pump relay, and apply pesticide to the area to be irrigated by turning on the third solenoid valve and the third water pump.

19. The non-transitory computer-readable storage medium according to claim 18, wherein the agricultural irrigation method further comprises:
arranging a first flowmeter in the first pipeline, and in response to statistical data of the first flowmeter being greater than or equal to first preset flow data, generating a first turn-off instruction, wherein the first turn-off instruction is used to sequentially turn off the first water pump relay and the first solenoid valve relay;
arranging a second flowmeter in the second pipeline, and in response to statistical data of the second flowmeter being greater than or equal to second preset flow data, generating a second turn-off instruction, wherein the second turn-off instruction is used to sequentially turn off the second water pump relay and the second solenoid valve relay; and
arranging a third flowmeter in the third pipeline, and in response to statistical data of the third flowmeter being greater than or equal to third preset flow data, generating a third turn-off instruction, wherein the third turn-off instruction is used to sequentially turn off the third water pump relay and the third solenoid valve relay.
